(19) United States
(12) Patent Application Publication
(10) Pub. No.: US 2013/0032673 A1
(43) Pub. Date: Feb. 7, 2013

(54) SOLAR POWER SATELLITE SYSTEM FOR TRANSMITTING MICROWAVE ENERGY TO THE EARTH AND METHOD OF ARRANGING A SOLAR POWER SATELLITE SYSTEM ABOUT THE SUN FOR SAME

(71) Applicant: Satoshi Kobayashi, Hitachi City (JP)

(72) Inventor: Satoshi Kobayashi, Hitachi City (JP)

(21) Appl. No.: 13/197,085

(22) Filed: Aug. 3, 2011

(51) Int. Cl. B64G 1/10; H02J 17/00; B64G 1/24; B64G 1/44; B64G 1/66

(52) U.S. Cl. 244/158.4; 244/172.7; 244/164; 244/159.4; 307/149

(57) ABSTRACT

Solar power satellite system for transmitting microwave energy to the earth and a method of arranging the solar power satellite system about the sun for same. The solar power satellite system comprises a space-based power generation unit disposed in a planetary orbit about the sun. A photovoltaic cell on the space-based power generation unit collects solar energy that is then converted to microwave energy to be beamed to the earth. A ground-based rectenna receives the microwave energy and converts the microwave energy to electricity that is transmitted to an end user. The solar power satellite system and method provides electrical power on earth day or night and regardless of atmospheric conditions. Also, surface area of the solar panel on the space-based power generation unit orbiting about the sun is much less than the surface area required of a ground-based solar panel or a solar panel in earth orbit.

### FIELD OF THE INVENTION

This invention generally relates to solar power satellites and more particularly relates to solar power satellite systems.

### BACKGROUND OF THE INVENTION

Fossil fuels (i.e., oil, coal and natural gas) supply about 86% of all energy consumption worldwide. More specifically, worldwide energy consumption percentages from oil, coal and natural gas are about 37.3%, 25.3% and 23.3%, respectively. Sources of energy other than from fossil fuels include nuclear, solar energy captured by solar photovoltaic cells, solar heat, biomass, biofuels, hydroelectric, wind, and geothermal. However, depending on the geographic location where energy is consumed, consumption of energy from these other sources is much less than from fossil fuels. Worldwide energy demand continues to grow at an increasing rate as developing countries in Asia, Central America and South America increase their energy usage. It has been projected that worldwide energy consumption will rise about 39% over the next 20 years. According to one estimate, at current consumption rates, readily available oil reserves will last about 40 years, coal reserves will last about 210 years and natural gas reserves will last about 60 years.

The United States consumes about 25% of the world's energy. In the United States, fossil fuels supply about 85% of all energy used. As a percentage of energy use in the United States, oil accounts for about 40%, coal accounts for about 22%, and natural gas accounts for about 23% of energy usage. Although use of renewable energy sources continues to increase, it is projected that demand for energy from fossil fuels will not abate in the near future. Therefore, depletion of fossil fuel reserves is a growing concern to both developed and developing countries.

Fossil fuels are used because use of fossil fuels obtains various advantages compared to other sources of energy. For example, fossil fuels are readily available. Fossil fuels use combustion processes that are well understood. In addition, use of fossil fuels is reasonably inexpensive compared to other sources of energy and the energy from fossil fuels can be readily distributed to an end user.

However, use of fossil fuels presents environmental challenges. In this regard, use of fossil fuels produces environmental pollution, such as carbon dioxide, that may contribute to undesirable climate change. Drilling for oil can damage the environment due to inadvertent release of oil from oil rig drilling platforms and transportation of oil can damage the environment due to oil leaks from pipelines and ocean-going tankers. In addition to carbon dioxide, burning of coal produces sulfur dioxide, which can lead to corrosive “acid rain.” Acid rain is acidic and can harm plants, aquatic animals and damage building structures. Also, mining of coal can alter vast tracts of land in an undesirable manner and pose safety risks for miners. Transportation and use of natural gas requires particular attention to safety because natural gas is highly flammable. Also, finding natural gas leaks may be difficult because natural gas is colorless, odorless and tasteless.

An alternative to use of energy from fossil fuels is use of energy from the sun. If used economically, solar power offers a virtually unlimited supply of energy and obviates the need to deplete the earth's energy resources. In this regard, useful energy from solar power is produced either by use of active solar apparatus (e.g., photovoltaics) or by use of passive solar techniques (e.g., positioning a building to more favorably receive sunlight; storing solar energy in a body mass during the day when it is warmer and releasing the energy from the body mass during the night when it is cooler; e.t.c.). Photovoltaic cells provide the most common technology to convert solar energy to electricity. In this regard, photovoltaic cells receive photons present in sunlight and convert the photons to direct current electricity by means of the photoelectric effect. The direct current electricity is then converted to alternating current electricity and transmitted over an electrical transmission and distribution grid to end users.

However, use of ground-based solar power may be limited by several factors. For example, solar energy may be absorbed by the atmosphere or obscured by clouds and dust. Also, availability of solar energy is limited at higher and lower latitudes where the sun is at low angles with respect to the earth. In addition, ground-based solar energy is completely absent during the night. Further, central station generation of electricity from ground-based solar panels requires allocation of large land areas. In this regard, it has been estimated that to generate 250 megawatts of electricity using photovoltaic solar panels might require about 65 million square feet (i.e., 1,492 acres) of land area. Further, at present, manufacture and deployment of solar panels may be more expensive than exploitation of fossil fuels.

A prior art proposal to use solar power, while avoiding some of its disadvantages, employs launching a satellite into either geosynchronous (i.e., stationary) satellite orbit, low earth satellite orbit (i.e., about 1,240 miles above earth's surface) or sun synchronous satellite orbit (i.e., ascending and descending orbit during a mean solar day). Such orbits are referred to herein as “satellite orbits” because they are orbits about the earth. In the prior art, the satellite in satellite orbit would include photovoltaic cells to capture solar energy and then convert the solar energy to microwaves. The microwave energy would then be beamed from the satellite in satellite orbit to a receiving station on earth and converted into electricity. Use of solar power in this manner to generate electricity could be virtually pollution-free and would not be disrupted by atmospheric conditions, cloud obscuration, dust, and the sun's angle with respect to the earth. Also, use of solar power in this manner may also reduce the requirement that large land areas be allocated for solar collectors.

However, use of such a satellite in satellite orbit would result in a primary disadvantage. In this regard, locating the satellite in satellite orbit would cause the satellite to be in earth's shadow at least some of the time. While in earth's shadow, the satellite would not have access to sunlight, and therefore would not produce microwaves that could be beamed to earth to generate electricity.

In addition, the surface area on the earth that is irradiated by microwave energy produced by the satellite in satellite orbit is relatively small. Such a relatively small area might require an increased number of satellites and receiving stations to generate a desired amount of electricity. Increasing the number of satellites and receiving stations may result in increased costs to generate the desired amount of electricity.

Hence, the prior art approach mentioned hereinabove to mitigate dependence on fossil fuels includes producing microwaves from a solar satellite positioned in satellite orbit and beaming the microwaves to earth to generate electricity. However, the prior art approach mentioned hereinabove does not appear to satisfactorily address the concern related to the satellite in satellite orbit being in earth's shadow at least some of the time and the concern related to the relatively small land area irradiated by the microwave energy produced from the satellite in satellite orbit.

### SUMMARY OF THE INVENTION

The present invention addresses the shortcomings of the prior art approach mentioned hereinabove by providing a solar power satellite system for transmitting microwave energy to the earth and a method of arranging the solar power satellite system about the sun for transmitting the microwave energy to the earth. According to the invention, the solar power satellite system and method provides continuous electrical power on earth regardless of the earth's shadow, angle of the sun with respect to the earth, or whether it is day or night at a particular location on the earth. Also, according to the invention, the solar power satellite system and method provides for irradiating a relatively larger land area with microwave energy as compared to a satellite in satellite orbit.

More specifically, the solar power satellite system comprises a space-based power generation unit advantageously disposed in a planetary orbit. The terminology “planetary orbit” is defined herein to mean an orbit about the sun. Such a planetary orbit is distinguishable from a “satellite orbit”, which is an orbit about the earth. A photovoltaic cell belonging to the space-based power generation unit collects the solar energy and converts the solar energy to electricity. A microwave generator is used to convert the electricity to microwave energy that is beamed to earth by a microwave transmission antenna. A ground-based rectenna receives the microwave energy and converts the microwave energy to electricity that is transmitted to an end user.

Also, surface area of the solar panel on the space-based power generation unit that is arranged in planetary orbit can be much less than the surface area required of a ground-based solar panel or a solar panel positioned in satellite orbit. This may result in a cost savings because fewer solar photovoltaic cells are required.

According to an aspect of the present invention, there is provided a solar power satellite system for transmitting microwave energy to the earth, the solar power satellite system comprising: a space-based power generation unit adapted to be disposed in an orbit about the sun, the sun being capable of emitting solar energy, the space-based power generation unit including: a chassis; a photovoltaic solar cell coupled to the chassis for receiving the solar energy and for converting the solar energy to electricity; a microwave generator coupled to the photovoltaic solar cell for receiving the electricity and for converting the electricity into microwave energy; and a microwave transmission antenna coupled to the microwave generator for transmitting the microwave energy to the earth.

According to another aspect of the present invention, there is provided a solar power satellite system for transmitting microwave energy to the earth, the solar power satellite system comprising: a space-based power generation unit adapted to be disposed in an orbit about the sun, the sun being capable of emitting solar energy, the space-based power generation unit being deployable at a predetermined distance from the sun and relative to the earth for irradiating a predetermined area on the earth with microwave energy, the space-based power generation unit including: a chassis; a photovoltaic solar cell coupled to the chassis for receiving the solar energy and for converting the solar energy into a first direct current electricity; a microwave generator coupled to the photovoltaic solar cell for receiving the first direct current electricity and for converting the first direct current electricity to the microwave energy; a microwave transmission antenna coupled to the microwave generator for transmitting the microwave energy to the earth; and a rectenna disposed on the earth and aligned with the microwave transmission antenna for receiving the microwave energy and for converting the microwave energy to a second direct current electricity.

According to yet another aspect of the present invention there is provided a method of arranging a solar power satellite system about the sun for transmitting microwave energy to the earth, the method comprising: providing a chassis; providing a photovoltaic solar cell coupled to the chassis for receiving the solar energy and for converting the solar energy to electricity; providing a microwave generator coupled to the photovoltaic solar cell for receiving the electricity and for converting the electricity to microwave energy; providing a microwave transmission antenna coupled to the microwave generator for transmitting the microwave energy to the earth; assembling a space-based power generation unit including the chassis, the photovoltaic solar cell, the microwave generator and the microwave transmission antenna; and disposing the space-based power generation unit in an orbit about the sun.

A feature of the present invention is the provision of a space-based power generation unit adapted to be disposed in an orbit about the sun.

Another feature of the present invention is the provision of a space-based power generation unit, wherein the space-based power generation unit is deployable at a predetermined distance from the sun.

An additional feature of the present invention is the provision of a space-based microwave reflector unit for reflecting microwave energy from the space-based power generation unit to the earth.

In addition to the foregoing, various other method and/or device aspects and features are set forth and described in the teachings such as text (e.g., claims and/or detailed description) and/or drawings of the present invention.

The foregoing is a summary and thus may contain simplifications, generalizations, inclusions, and/or omissions of detail. Consequently, those skilled in the art will appreciate that the summary is illustrative only and is not intended to be in any way limiting. In addition to the illustrative aspects, embodiments, and features described hereinabove, further aspects, embodiments, and features will become apparent by reference to the drawings and the following detailed description.

### BRIEF DESCRIPTION OF THE DRAWINGS

The invention will be more fully understood by reference to the detailed description in conjunction with the following figures, wherein:

FIG. 1 is a view in perspective of a first embodiment solar power satellite system for transmitting microwave energy to the earth;

FIG. 2 is a schematic illustrating, with parts removed for clarity, a first embodiment control subsystem belonging to the first embodiment solar power satellite system;

FIG. 3 is a view in perspective of a rectenna disposed on the earth for receiving the microwave energy and for converting the microwave energy to electricity;

FIG. 4 is a view in perspective of a second embodiment solar power satellite system for reflecting microwave energy to the earth;

FIG. 5 is a schematic illustrating, with parts removed for clarity, a second embodiment control subsystem belonging to the second embodiment solar power satellite system;

FIG. 6 is a view in perspective of a third embodiment solar power satellite system for reflecting microwave energy to a nighttime side of the earth;

FIG. 7 is a view in perspective of a fourth embodiment solar power satellite system for transmitting microwave energy to the earth;

FIG. 8 is a schematic illustration, with parts removed for clarity, of a fourth embodiment control subsystem belonging to the fourth embodiment solar power satellite system;

FIG. 9 is a view in perspective of a fifth embodiment solar power satellite system for transmitting microwave energy to the earth;

FIG. 10 is a schematic illustration, with parts removed for clarity, of a fifth embodiment control subsystem belonging to the fifth embodiment solar power satellite system;

FIG. 11 is a schematic illustration, with parts removed for clarity, of an ion thruster belonging to the fifth embodiment solar power satellite system;

FIG. 12 is a schematic illustration, with parts removed for clarity, of a first embodiment heat exchanger circuit belonging to any of the solar power satellite system embodiments for cooling any of the solar power satellite system embodiments;

FIG. 13 is a schematic illustration, with parts removed for clarity, of a second embodiment heat exchanger circuit belonging to any of the solar power satellite system embodiments for cooling any of the solar power satellite system embodiments; and

FIG. 14 is a flowchart of an illustrative method of arranging a solar power satellite system about the sun for transmitting microwave energy to the earth.

### DETAILED DESCRIPTION OF PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from either the spirit or scope of the invention.

In addition, the present patent specification uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

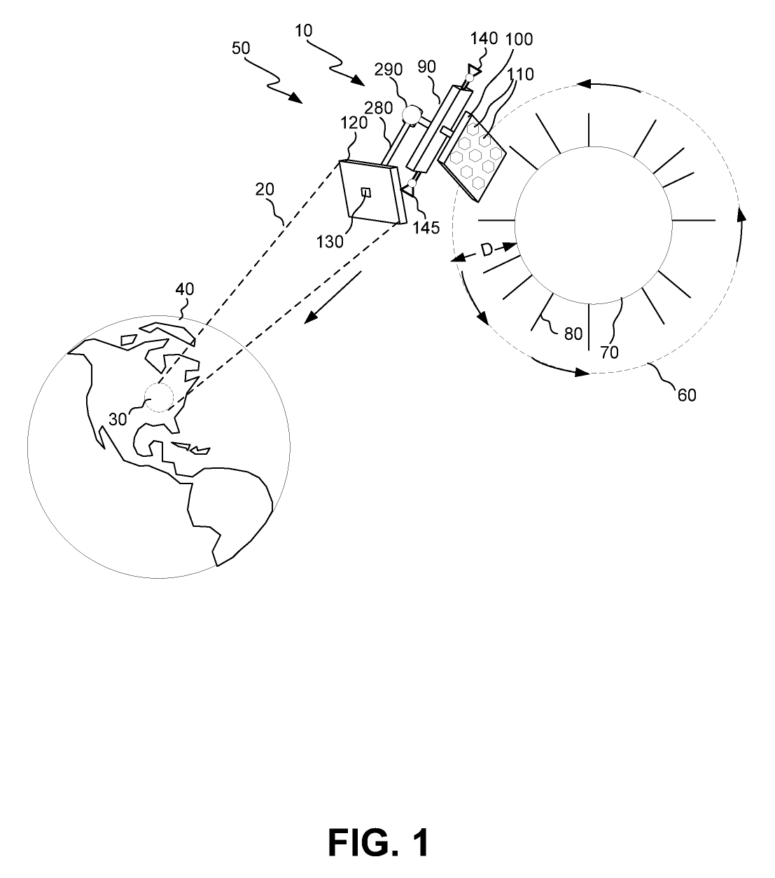

Therefore, with reference to FIG. 1, there is shown a first embodiment solar power satellite system, generally referred to as 10, for transmitting microwave energy 20 to a predetermined surface area 30 on the earth 40. As described in detail hereinbelow, first embodiment solar power satellite system 10 comprises a space-based power generation unit, generally referred to as 50, that is adapted to be disposed in a planetary orbit 60 about the sun 70. Planetary orbit 60 may be either a circular planetary orbit, an elliptical planetary orbit or an ascending/descending planetary orbit about the sun 70. Alternatively, space-based power generation unit 50 may be disposed in a geosynchronous (i.e., stationary) planetary orbit above a predetermined location on the surface of the sun 70. In this regard, when disposed in geosynchronous planetary orbit, space-based power generation unit 50 may be disposed so as to be stationary above a substantially inactive solar site (e.g., a sun spot) on the sun's surface. Disposing space-based power generation unit 50 above the substantially inactive solar site may reduce disruptive influence of the sun on the satellite's operation. As another alternative, space-based power generation unit 50 may be placed in planetary orbit 60 so that space-based power generation unit 50 does not travel behind the sun 70. In this case, space-based power generation unit 50 will not be in the “shadow” of the sun 70. Moreover, if desired, space-based power generation unit 50 may be disposed so as to be fixed at a predetermined location in space that is near the sun 70 but between the earth 40 and the sun 70. In this case, space-based power generation unit 50 will not orbit the sun 70 in any fashion. As a result, when space-based power generation unit 50 is fixed at the predetermined location that is near the sun 70 but between the earth 40 and the sun 70, space-based power generation unit 50 will never be in the “shadow” of the sun 70 because space-based power generation unit 50 will not be in orbit about the sun 70. Thus, in this case, receipt of microwave energy 20 by the earth 40 will not be interrupted due to presence of the sun 70 between space-based power generation unit 50 and the earth 40. For purposes of example only and not for purposes of limitation, the description hereinbelow presumes that space-based power generation unit 50 is disposed either in a circular planetary orbit, an elliptical planetary orbit, an ascending/descending planetary orbit or a geosynchronous planetary orbit about the sun 70.

Referring again to FIG. 1, the sun 70 emits solar energy 80. For reasons provided hereinbelow, while in planetary orbit 60, space-based power generation unit 50 is caused to be deployed at a predetermined distance “D” from the surface of the sun 70. Predetermined distance “D” is selected as near as possible to the sun 70 such that space-based power generation unit 50 will receive a maximum amount of solar energy 80 without heat damage to materials and components comprising space-based power generation unit 50. For example, predetermined distance “D” may be selected so as to avoid possible damage by solar flares. By way of example only, and not by way of limitation, the predetermined distance “D” may be approximately 1,500 kilometers (i.e., 932.06 miles) or more.

Still referring to FIG. 1, and as described in further detail hereinbelow, space-based power generation unit 50 includes a chassis 90 to which is coupled a solar panel 100 oriented toward the sun 70. Solar panel 100 comprises at least one solar cell 110 made from a material evincing a photoelectric effect. There are several suitable and well-known materials useable for this purpose. For example, the material evincing the photoelectric effect may be selected from the group consisting essentially of monocrystalline silicon, polycrystalline silicon, amorphous silicon, cadmium telluride, copper indium selenide, copper indium sulfide and mixtures thereof. Solar cell 110 converts the solar energy to electricity that is, in turn, converted into microwave energy 20. The microwave energy 20 is beamed to predetermined area 30 by a microwave antenna 120 that is coupled to chassis 90. Also, a laser beam sensor 130 is coupled to microwave antenna 120 for reasons provided hereinbelow. Propulsion devises or stabilizers that comprise a plurality of rocket nozzles (only two of which are shown), such as a first rocket nozzle 140 and a second rocket nozzle 145, are coupled to chassis 90 for stabilizing or maintaining space-based power generation unit 50 in orbit 60 and at predetermined distance “D”.

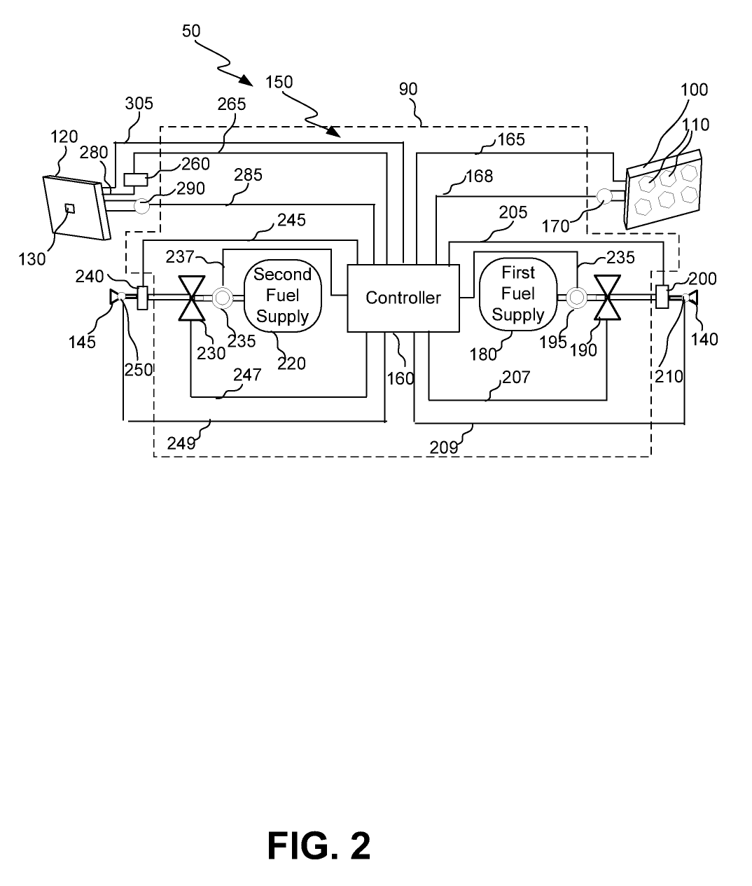

Referring to FIGS. 1 and 2, the structure and operation of first embodiment solar power satellite system 10 will now be described in detail. In this regard, coupled to chassis 90 is an on-board first embodiment control subsystem, generally referred to as 150. First embodiment control subsystem 150 comprises a controller 160 coupled to previously mentioned chassis 90 for controlling operation of various components of first embodiment solar power satellite system 10. Controller 160 comprises a plurality of suitable semiconductor devices (not shown) and circuitry (also not shown) programmed to accomplish its purpose of controlling operation of the various components of first embodiment solar power satellite system 10. In order to power controller 160, direct electrical current is supplied to controller 160 along a first electrical path 165 extending from solar panel 100 to controller 160. As described in detail presently, controller 160 is not only capable of using the electrical current to operate the semiconductor devices and circuitry comprising controller 160, the controller 160 is also capable of controllably supplying an amount of the electrical current to the various other components of space-based power generation unit 50 in order to operate those components.

Therefore, referring again to FIGS. 1 and 2, controller 160 supplies an electrical control signal along a second electrical path 168 to an electrically-operable first motorized pivot support 170. The first motorized pivot support 170 is coupled to solar panel 100 for orienting solar panel 100 with respect to the sun 70. In response to the control signal received by first motorized pivot support 170, the first motorized pivot support 170 will pivot to a selected one of a plurality of possible angles for angular orientation of solar panel 100 with respect to the sun 70. In this manner, solar panel 100 can be optimally oriented to efficiently collect and convert solar energy 80 to direct current electricity.

Still referring to FIGS. 1 and 2, previously mentioned first rocket nozzle 140, which is coupled to chassis 90, stabilizes or maintains space-based power generation unit 50 in planetary orbit 60 and at predetermined distance “D”. More specifically, a first fuel supply 180 containing a suitable propellant is coupled to an electrically energizable first motorized valve 190 operable to controllably provide the propellant from first fuel supply 180 to a first ignition chamber 200. An electrically energizable first pump 195 may be interposed between and coupled to first fuel supply 180 and first motorized valve 190 for pumping the propellant from first fuel supply 180 and to first motorized valve 190. First pump 195 is electrically coupled to controller 160, such as by means of a first conductor 197, for controlling operation of first pump 195 by supplying an electrical control signal to first pump 195. Controller 160 supplies an electrical control signal along a third electrical path 205 to first ignition chamber 200 for controllably igniting propellant allowed to pass into first ignition chamber 200 by operation of first motorized valve 190. First motorized valve 190 is controllably operated by means of controller 160 that supplies an electrical control signal to first motorized valve 190 by means of a fourth electrical path 207. First rocket nozzle 140 is in communication with first ignition chamber 200 for exhausting ignited propellant from first rocket nozzle 140, so as to stabilize or maintain space-based power generation unit 50 in planetary orbit 60 and at predetermined distance “D”. In addition, controller 160 supplies an electrical control signal along a fifth electrical path 209 to an electrically-operable second motorized pivot support 210 for purposes disclosed presently. In this regard, second motorized pivot support 210 is coupled to first rocket nozzle 140. In response to the control signal received by second motorized pivot support 210, the second motorized pivot support 210 will pivot to a selected one of a plurality of possible angles. Pivoting of second motorized pivot support 210 will cause first rocket nozzle 140 to pivot a like extent. Pivoting of first rocket nozzle 140 will, in turn, precisely stabilize or maintain space-based power generation unit 50 in the preferred planetary orbit 60 and at the preferred predetermined distance “D”.

Referring yet again to FIGS. 1 and 2, previously mentioned second rocket nozzle 145, which is also coupled to chassis 90, cooperates with first rocket nozzle 140 to stabilize or maintain space-based power generation unit 50 in planetary orbit 60 and at predetermined distance “D”. More specifically, a second fuel supply 220 containing the propellant is coupled to an electrically energizable second motorized valve 230 operable to controllably provide the propellant from second fuel supply 220 to a second ignition chamber 240. An electrically energizable second pump 235 may be interposed between and coupled to second fuel supply 220 and second motorized valve 230 for pumping the propellant from second fuel supply 220 and to second motorized valve 230. Second pump 235 is electrically coupled to controller 160, such as by means of a second conductor 237, for controlling operation of second pump 235 by supplying an electrical control signal to second pump 235. Controller 160 supplies an electrical control signal along a sixth electrical path 245 to second ignition chamber 240 for controllably igniting propellant allowed to pass into second ignition chamber 240 by operation of second motorized valve 230. Second motorized valve 230 is controllably operated by means of controller 160 that supplies an electrical control signal to second motorized valve 230 by means of a seventh electrical path 247. Second rocket nozzle 145 is in communication with second ignition chamber 240 for exhausting ignited propellant from second rocket nozzle 145, so as to stabilize or maintain space-based power generation unit 50 in orbit 60 and at predetermined distance “D”. In addition, controller 160 supplies an electrical control signal along an eighth electrical path 249 to a third motorized pivot support 250 for purposes disclosed presently. In this regard, third motorized pivot support 250 is coupled to second rocket nozzle 145. In response to the control signal received by third motorized pivot support 250, the third motorized pivot support 250 will pivot to a selected one of a plurality of possible angles. Pivoting of third motorized pivot support 250 will cause second rocket nozzle 145 to pivot a like extent. Pivoting of second rocket nozzle 145 will, in turn, precisely stabilize or maintain space-based power generation unit 50 in the preferred planetary orbit 60 and at the preferred predetermined distance “D”. It should be appreciated that controller 160 is capable of pivoting and operating first rocket nozzle 140 and second rocket nozzle 145 either individually or simultaneously to stabilize or maintain space-based power generation unit 50 in planetary orbit 60 and at predetermined distance “D”. Also, it should be appreciated that controller 160 is adapted to control first rocket nozzle 140 and second rocket nozzle 145 such that the amount of rocket thrust or exhaust from first rocket nozzle 140 and second rocket nozzle 145 may be the same or different in order to provide precise positioning of space-based power generation unit 50 in planetary orbit 60 and at predetermined distance “D”. Although the disclosure hereinabove contemplates use of a propellant and rocket nozzles 140/145, alternative propulsion means may be used for stabilizing or maintaining space-based power generation unit 50 in planetary orbit 60 and at predetermined distance “D”. Examples of such alternative propulsion means are presented hereinbelow.

Referring again to FIGS. 1 and 2, controller 160 is electrically coupled to a microwave generator 260, such as by means of a ninth electrical path 265. Microwave generator 260 receives direct current electricity from controller 160 along ninth electrical path 265 and converts the direct current electricity to microwave energy. The microwave energy is guided to previously mentioned microwave transmission antenna 120, such as by means of a suitable wave guide 280 interconnecting microwave generator 260 and microwave transmission antenna 120. Microwave transmission antenna 120 accepts the microwave energy guided to it and transmits the microwave energy to the earth 40 in the form of a beam of microwave energy 20. In addition, a tenth electrical path 285 interconnects controller 160 to a fourth motorized pivot support 290 that is coupled to microwave transmission antenna 120. An electrical control signal is supplied from controller 160, along tenth electrical path 285 and to fourth motorized pivot support 290, to controllably pivot fourth motorized pivot support 290 to a selected one of a plurality of possible angles. Pivoting of fourth motorized pivot support 290 will cause microwave transmission antenna 120 to pivot a like extent. Pivoting of microwave transmission antenna 120 in this manner will, in turn, orient microwave transmission antenna 120 in a desired direction (e.g., toward predetermined surface area 30 on the earth 40).

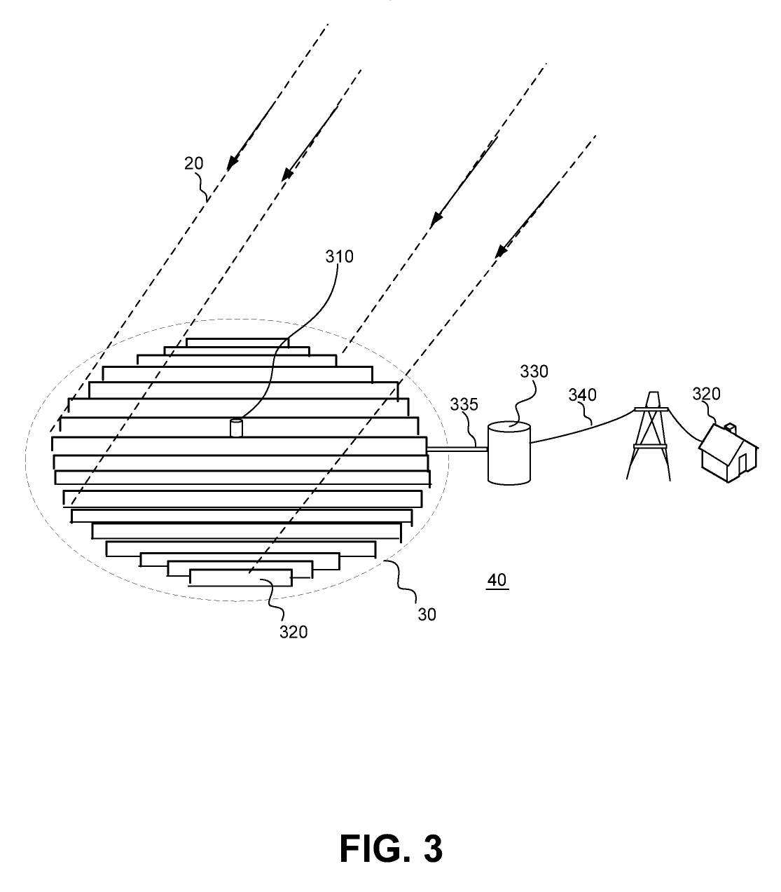

Moreover, still referring to FIGS. 1 and 2, coupled to microwave transmission antenna 120 is a laser beam sensor 130 adapted to be in sensing communication with a laser beacon 310, that emits a laser beam (not shown), for aligning microwave transmission antenna 120 with laser beacon 310 (see FIG. 3). Laser beacon 310 is located at predetermined surface area 30 on the earth 40. Further, as shown in FIGS. 1 and 2, controller 160 is coupled to laser beam sensor 130, such as by an eleventh electrical path 305, for electrically energizing laser beam sensor 130. When electrically energized, laser beam sensor 130 is capable of generating an electrical signal identifying whether or not the laser beacon 310 and the laser beam produced therefrom are detected. More specifically, and as previously mentioned, laser beam sensor 130 is coupled to microwave transmission antenna 120. Also, as previously mentioned, microwave transmission antenna 120 can be pivoted by operation of controller 160. Thus, laser beam sensor 130 moves together with microwave transmission antenna 120. Controller 160, which is coupled to laser beam sensor 130 and microwave transmission antenna 120, will controllably pivot microwave transmission antenna 120 through a plurality of positions or angles until the laser beam is detected by laser beam sensor 130. In this regard, and as previously mentioned, controller 160 controls pivoting of fourth motorized pivot support 290 that, in turn, controls pivoting of microwave transmission antenna 120, which allows laser beams sensor 130 to detect the laser beam. The electrical signal generated by laser beam sensor 130 is returned along eleventh electrical path 305 to controller 160. When the laser beam from laser beacon 310 is detected, controller 160 will then cooperatively operate pivot supports 190/210/290, rocket nozzles 140/145 and microwave transmission antenna 120 to precisely position microwave transmission antenna 120 into alignment with laser beacon 310.

With reference to FIGS. 1, 2 and 3, a conventional rectenna 320 is disposed at predetermined surface area 30 on the earth 40 for receiving microwave energy 20 and for converting microwave energy 20 into direct current electricity. Laser beam sensor 130, that belongs to space-based power generation unit 50, detects location of rectenna 320 by sensing the laser beam emitted by previously mentioned laser beacon 310. The laser beacon 310 is disposed near rectenna 320, such as being disposed at the center of rectenna 320. In this manner, microwave transmission antenna 120 can be aligned with rectenna 320. The direct current electricity produced by rectenna 320 is passed to a conventional direct current-to-alternating current converter 330, such as by means of electrical conducting cable 335, for converting the direct current electricity to alternating current electricity. The alternating current electricity is then delivered over an electrical transmission grid 340 to an end user facility 350 in a manner well understood in the art.

It may be appreciated that when space-based power generation unit 50 is either in circular planetary orbit, elliptical planetary orbit, ascending/descending planetary orbit or geosynchronous planetary orbit above the sun 70, space-based power generation unit 50 may eventually come in the shadow of the sun 70. The terminology “in the shadow of the sun 70” is defined herein to mean that the sun 70 is at a position between the earth 40 and space-based power generation unit 50. When this occurs, microwave energy 20 from space-based power generation unit 50 cannot be beamed directly to the earth 40 because the sun 70 will obstruct transmission of microwave energy 20. As described in detail hereinbelow, use of applicant's invention addresses this concern.

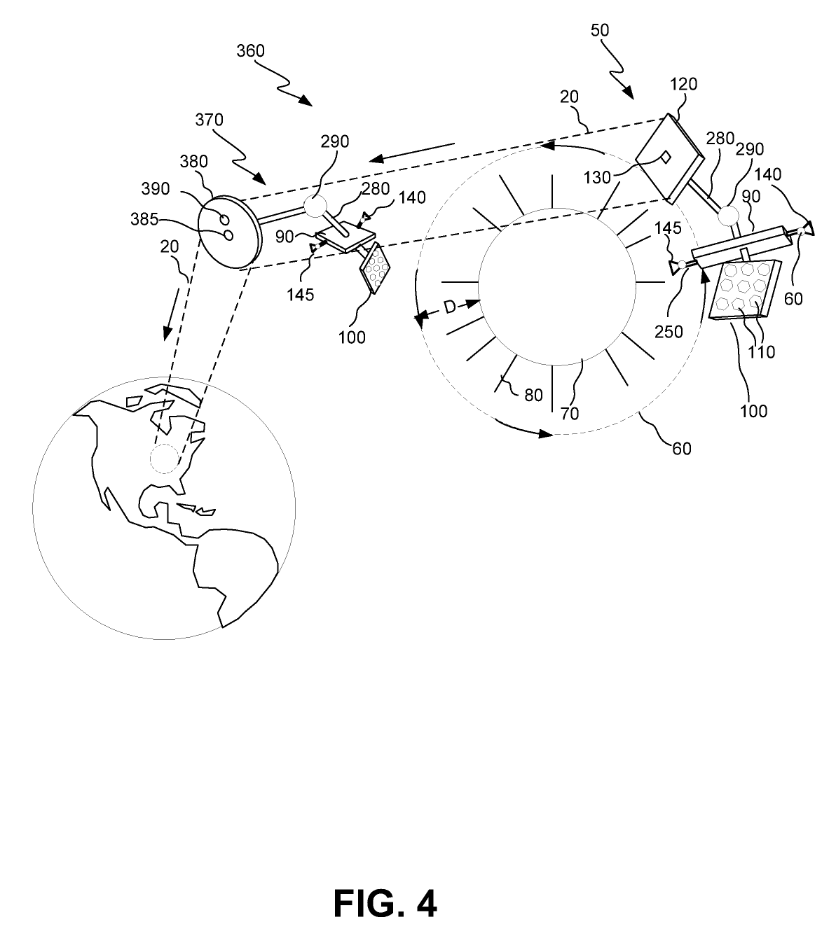

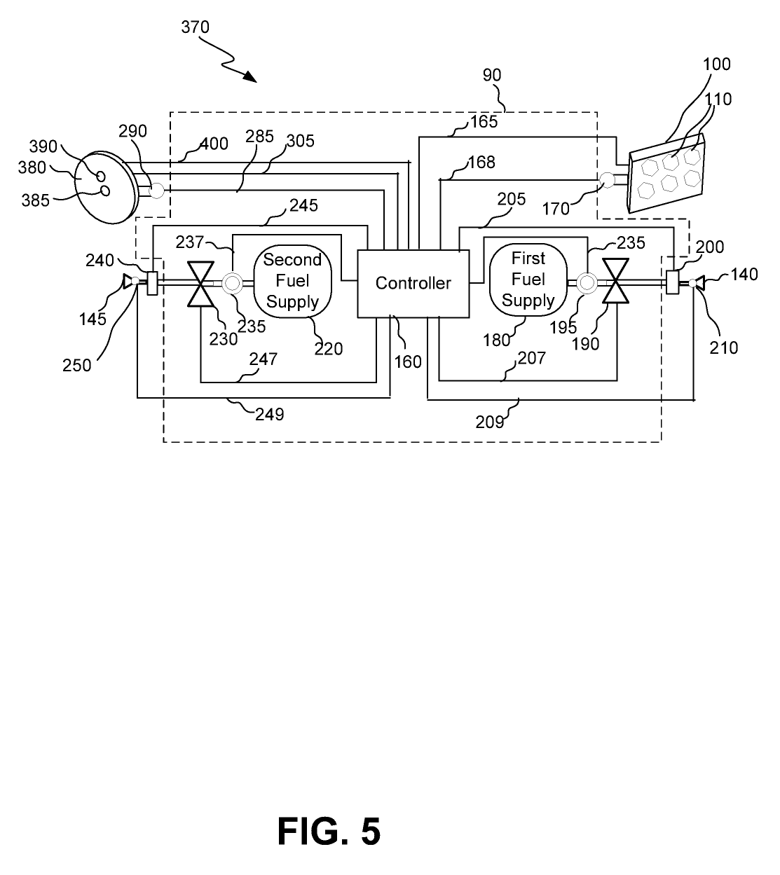

Therefore, referring to FIGS. 4 and 5, there is shown a second embodiment solar power satellite system, generally referred to as 360, for reflecting microwave energy 20 from space-based power generation unit 50 to the earth 40 when space-based power generation unit 50 is in the shadow of the sun 70. In other words, by use of the invention, the sun 70 will not interfere with receipt of microwave energy 20 by the earth 40 even when space-based power generation unit 50 is in the shadow of the sun 70. More specifically, second embodiment solar power satellite system 360 comprises a reflector unit, generally referred to as 370, that is substantially similar to space-based power generation unit 50, except in respects described momentarily. In this regard, reflector unit 370 reflects microwave energy 20 rather than generating microwave energy 20. Therefore, reflector unit 370 lacks microwave generator 260, ninth electrical path 265, microwave transmission antenna 120 and wave guide 280. Rather, reflector unit 370 comprises a reflector dish 380, instead of microwave transmission antenna 120, for reflecting microwave energy 20 from space-based power generation unit 50 and to the earth 40. Reflector dish 380 may have any suitable shape, such as a parabolic shape for efficiently directing microwave energy 20 into a focused beam. In addition, reflector dish 380 may have a mesh-like construction, rather than a solid metal construction, for reducing weight of reflector unit 370 when reflector unit 370 is launched into space from the earth 40. It is known that a mesh-like construction is as efficient as a solid construction for reflecting microwave energy. Also, reflector dish 380 comprises any suitable microwave reflecting material, such as, without limitation, polished silver, gold, steel or aluminum. Coupled to reflector dish 380 is a laser beam sensor or detector 385 for sensing or detecting the laser beam emitted by laser beacon 310 that is located at rectenna 320. Laser beam detector 385 operates in the same manner as mentioned hereinabove for laser beam sensor 130 in the case of space-based power generation unit 50. Laser beam detector 385 is coupled to controller 160 in reflector unit 370, such as by a twelfth electrical path 400, so that laser beam detector 385 is controllably operated by controller 160. Also coupled to reflector dish 380 is a laser 390 adapted to emit a laser beam detectable by laser beam sensor 130 that belongs to space-based power generation unit 50. When the laser beam emitted by laser 390 is detected by laser beam sensor 130, controller 160 on space-based power generation unit 50 operates microwave generator 260 to transmit microwaves from microwave transmission antenna 120. The microwaves transmitted by microwave transmission antenna 120 will be in the direction of the source of the laser beam emitted by laser 390 and that is detected by laser beam sensor 130. It may be appreciated that, in combination with operation of rocket nozzles 140/145, operation of laser sensor 130, laser beacon 310, laser beam detector 285 and laser 390 allow microwave transmission antenna 120, reflector dish 280 and rectenna 320 to be brought into simultaneous alignment for reflecting microwave energy 20 to the earth 40. More specifically, rocket nozzles 140/145, motorized pivot supports 170/210/250/290, laser beam sensor 385 and laser 390 are controllably operated by controller 160 in reflector unit 370 and space-based power generation unit 50 to bring reflector dish 380 into simultaneous alignment with laser beacon 310 on the earth 40 and laser beam sensor 130 on space-based power generation unit 50. In other words, reflector dish 380 can be maneuvered into simultaneous alignment with rectenna 320 and microwave transmission antenna 120. In this manner, microwaves transmitted by microwave transmission antenna 120 will be received by reflector dish 380 and thereafter reflected to rectenna 320 that is disposed on the earth 40 even when space-based power generation unit 50 is in the shadow of the sun 70.

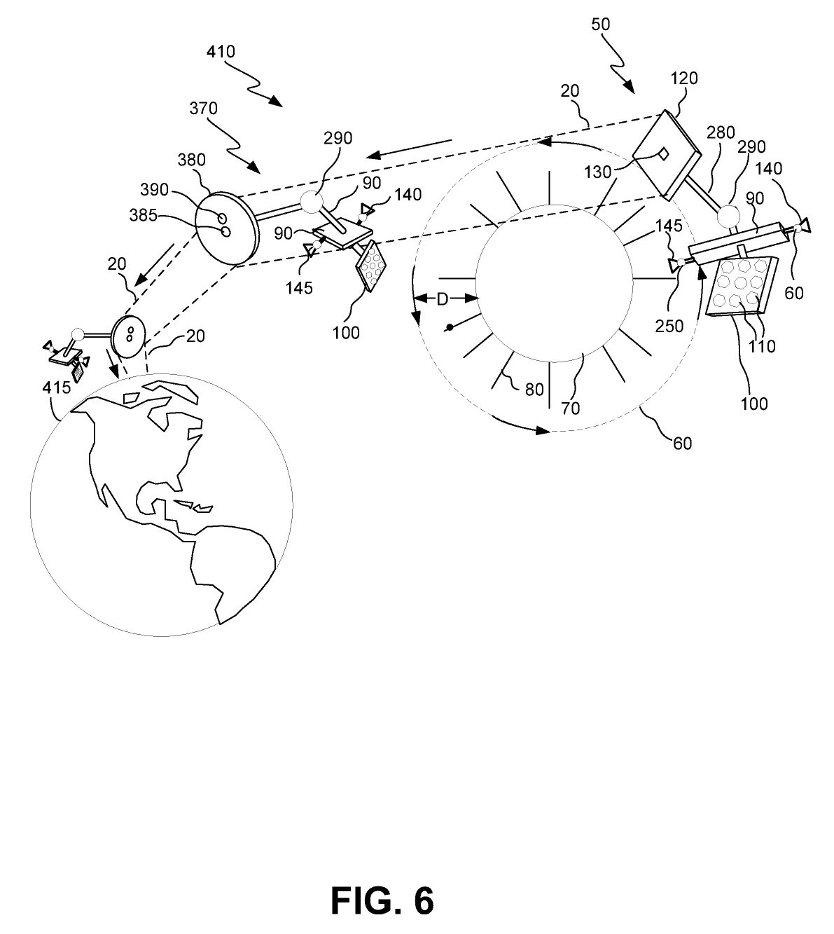

As best seen in FIG. 6, there is shown a third embodiment solar power satellite system, generally referred to as 410, for reflecting microwave energy 20 to rectenna 320 disposed at a predetermined location (not shown) on a nighttime side 415 of the earth 40.

The terminology “on the nighttime side 415 of the earth 40” is defined herein to mean a side of the earth 40 not facing the sun 70. More specifically, a plurality of reflector units 370 are arranged relative to the earth 40, so that at least one of the plurality of reflector units 370 is deployed to reflect microwave energy 20 to rectenna 320 that may be disposed at the predetermined location on the nighttime side 415 of the earth 40. Microwave energy 20 is beamed from microwave transmission antenna 120 that belongs to space-based power generation unit 50 to a selected one of the plurality of reflector units 370, which then reflects the microwave energy 20 to another one of the plurality of the reflectors 370 that is deployed on the nighttime side 415 of the earth 40. The reflector 370 that is deployed on the nighttime side 415 of the earth 40 then reflects microwave energy 20 to rectenna 320 that may be disposed on the nighttime side 415 of the earth 40. Therefore, use of third embodiment solar power satellite system 410 allows microwave energy 20 to be continuously beamed to rectenna 320 located anywhere on the earth 40 and at any time of day or night. It should be understood that this is true even when space-based power generation unit 50 is in the shadow of the sun 70.

Also, it should be appreciated that surface area of solar panel 100 on space-based power generation unit 50 that is arranged in planetary orbit 60 about the sun 70 can be much less than the surface area required of a ground-based solar panel. Also, surface area of solar panel 100 on space-based power generation unit 50 can be much less than the surface area of a solar panel positioned in satellite orbit about the earth 40. This is so because, being closer to the sun 70, solar panel 100 will receive greater solar energy photon fluence than the solar energy photon fluence received by a ground-based solar panel or a solar panel in satellite orbit. Also, the sun 70 is about 150,000,000 kilometers from the earth 40. If a one square meter microwave transmission antenna 120 is disposed about 1,500 km from the surface of the sun 70, microwave energy 20 will cover a relatively large surface area 30 of about 100 square kilometers on the earth 40. In other words, a one square meter solar panel disposed in planetary orbit 60 can be equivalent to a 10,000 square meter solar panel disposed in satellite orbit. Therefore, placement of space-based power generation unit 50 in planetary orbit 60 about the sun 70, rather than on the earth 40 or in satellite orbit about the earth 40, provides a beneficial result by allowing a larger surface area on the earth 40 to receive microwave energy 20. This is so because, being nearer to the sun 70, operation of space-based power generation unit 50 is about 100 times more efficient than operation of a solar power panel in satellite orbit or a ground-based solar power panel. This result substantially decreases need for fossil fuel and thermal power generating plants and, therefore, significantly reduces carbon dioxide emissions into the atmosphere.

It may be appreciated that space-based power generation unit 50 belonging to either of first, second or third embodiment solar power satellite systems 10/360/410, respectively, can be launched by means of a suitable space vehicle (not shown). Also, it may be appreciated that controller 160 may be operated by an on-board, pre-programmed computer program stored in controller 160 and/or by radio control signals received from the earth 40.

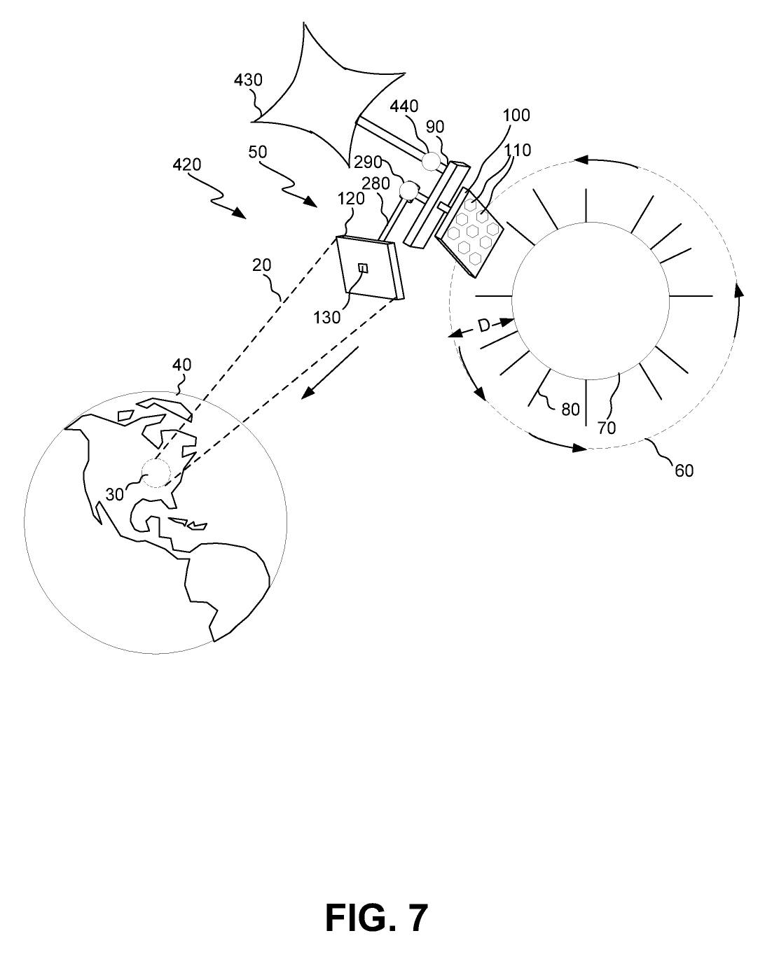

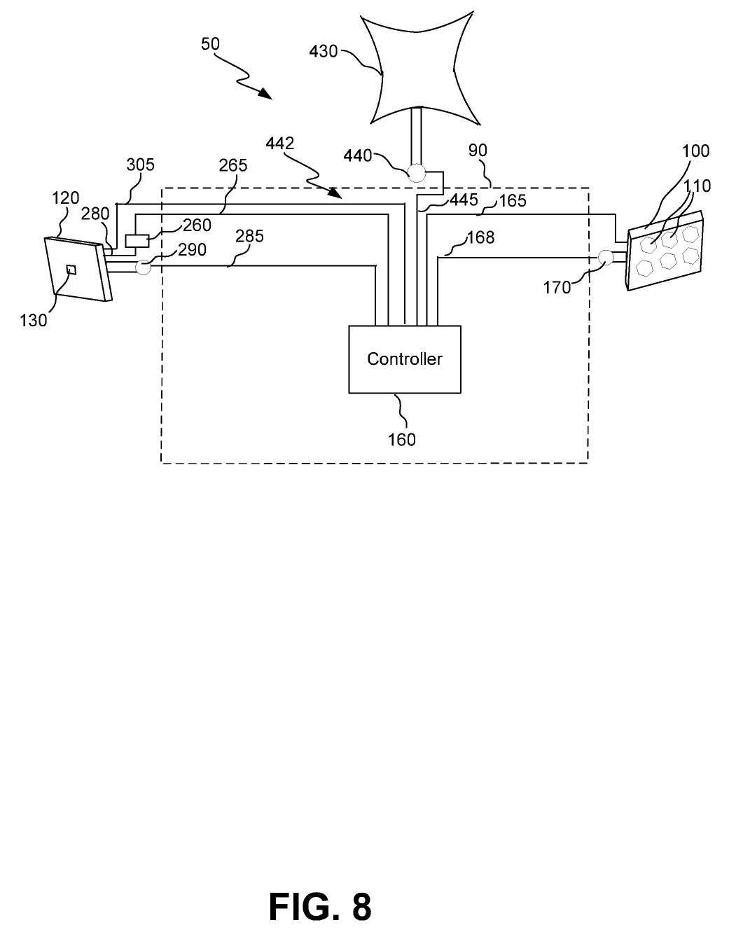

Referring to FIGS. 7 and 8, there is shown a fourth embodiment solar power satellite system, generally referred to as 420, which includes alternative propulsion means for stabilizing or maintaining space-based power generation unit 50 in planetary orbit 60 and at predetermined distance “D”. Fourth embodiment solar power satellite system 420 includes a solar sail 430 supported by a motorized solar sail pivot support 440 that is adapted to pivot through a plurality of angles. When solar sail pivot support 440 pivots, solar sail 430 pivots to a like extent to orientate solar sail 430 with respect to the sun 70. Spaced-based power generation unit 50 that belongs to fourth embodiment solar power satellite system 420 includes a second embodiment control subsystem 442. The second embodiment control subsystem 442 includes previously mentioned controller 160. Controller 160 is electrically coupled to solar sail pivot support 440, such as by means of a thirteenth electrical path 445, for controllably pivoting solar sail pivot support 440. It may be appreciated that solar sail 420 may be used in combination with rocket nozzles 140/145 for propulsion of space-based power generation unit 50, if desired. Moreover, it is known that solar sail 420 may be relatively thin (e.g., about 0.1 micrometers) and made of a suitable material, such as aluminum. Solar energy 80 will exert a sufficient force on solar sail 420 to allow the orbital centrifugal force experienced by space-based power generation unit 50 to overcome the centripetal gravitational force exerted by the sun 70.

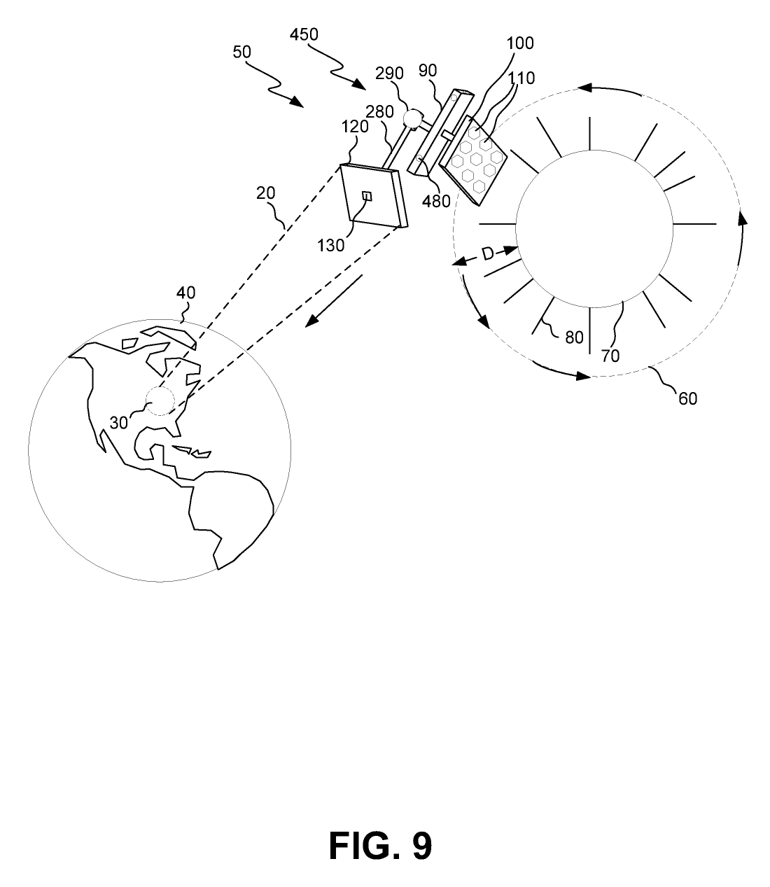

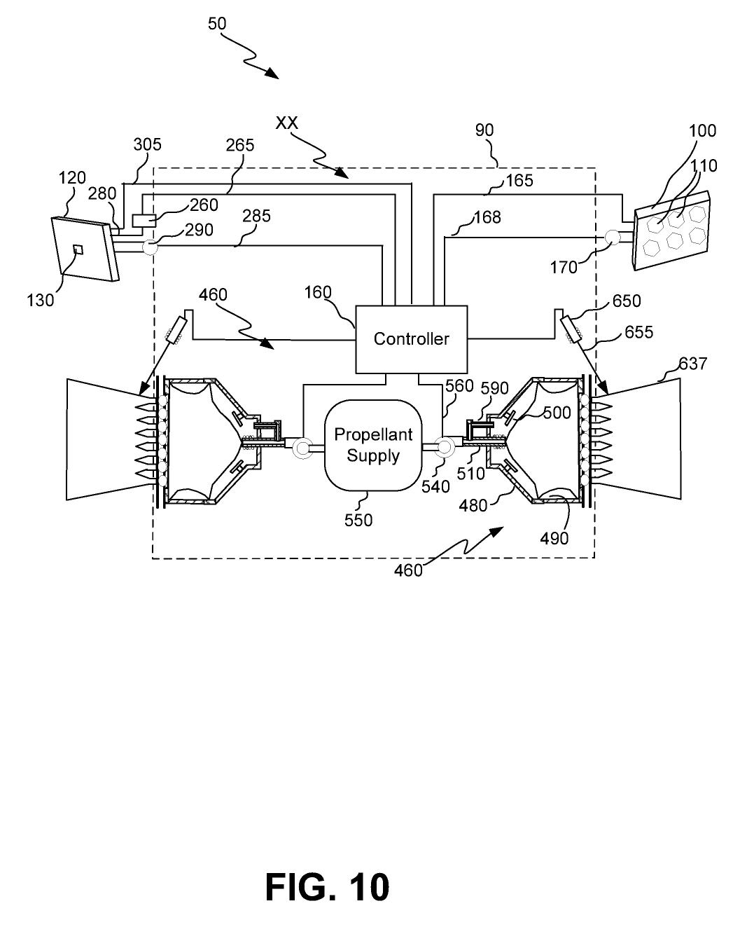

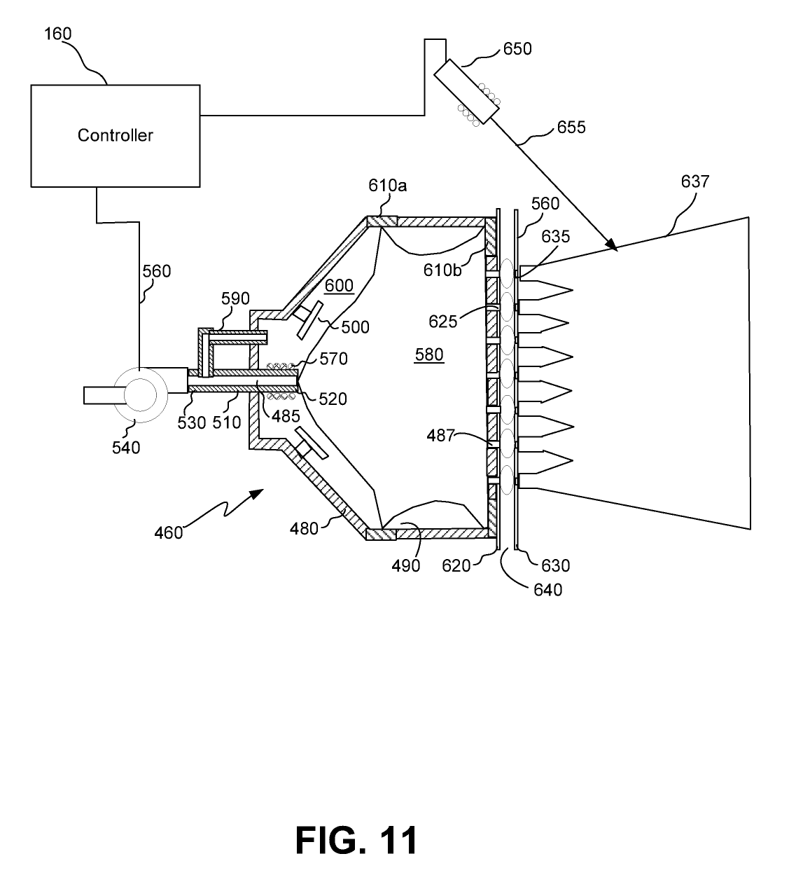

Referring to FIGS. 9, 10 and 11, there is shown a fifth embodiment solar power satellite system, generally referred to as 450, which includes alternative propulsion means for stabilizing or maintaining space-based power generation unit 50 in planetary orbit 60 and at predetermined distance “D”. Fifth embodiment solar power satellite system 450 includes at least one electric propulsion device or ion thruster, generally referred to as 460. Ion thruster 460 may be a modification of a known configuration, such as an electrostatic ion thruster generally of the well-known Kaufman-type. Although a modified electrostatic ion thruster 460, generally of the Kaufman-type, is disclosed herein, it should be appreciated that alternative types of ion thrusters may be used, such as electromagnetic ion thrusters (not shown) or other types of ion thrusters (also not shown). Such alternative types of ion thrusters are intended to fall within the breadth and scope of the present invention.

Referring again to FIGS. 9, 10 and 11, electrostatic ion thruster 460 includes a shell 480 defining a chamber 490 therein. Shell 480 also defines at least one inlet opening 485 and at least one oppositely disposed outlet opening 487 in communication with chamber 490 for reasons disclosed hereinbelow. Disposed in chamber 490 and coupled to shell 480 is at least one anode 500 for reasons disclosed hereinbelow. A cathode 510 in the form of a conduit penetrates shell 480, so as to have a proximal end portion 520 disposed in chamber 490 and a distal end portion 530 coupled to an electrically operated pump 540. A purpose of cathode 510 is to bombard a neutral gas with electrons to create ionized gas or plasma. The pump 540 is coupled to a neutral gas propellant supply 550, which contains a suitable noble gas, such as Xenon. Controller 160 is coupled to pump 540, such as by means of a thirteenth electrical path 560, for operating pump 540. Controller 160 operates pump 540 to pump the Xenon gas from propellant supply 550, through first conduit 510 and into chamber 490. A resistance heater coil 570 surrounds proximal end portion 520 of cathode 510 for raising the temperature of cathode 510 to thermionic emission temperature before beginning initiation of an ion plasma discharge 580. The ion plasma discharge 580 is generated by interaction of electrons traveling between cathode 510, anode 500 and the neutral gas flow. The neutral gas flow may be supplied into chamber 490 by a conduit 590 extending from chamber 490 to distal end portion 530 of cathode 510. In this manner, the neutral gas will flow from distal end portion 530, through conduit 590 and into chamber 490. As the neutral gas flows into chamber 490, a neutral gas region 600 is established therein to enable the interaction of electrons traveling between cathode 510, anode 500 and the neutral gas flow.

Referring yet again to FIGS. 9, 10 and 11, a plurality of electrically energizable solenoids 610a and 610b are coupled to shell 480 and surround chamber 490 for generating a magnetic field that will have ionized the gas to create ion plasma discharge 580. Such solenoids 610a/610b are coupled to controller 160 for controllably energizing solenoids 610a/610b and may be in the form of annular rings. In addition, a first grid or sheath 620 having a plurality of first holes 625 is disposed near outlet openings 487. A second grid or accelerator 630 having a plurality of second holes 635 is disposed parallel to and spaced-apart from sheath 620, so as to define a gap 640 therebetween. As the ion plasma discharge 580 passes through outlet openings 487, first holes 625 and into gap 640, a potential difference between ion plasma discharge 580 and sheath 620 and accelerator 630 generates an electrostatic field that accelerates ion plasma discharge 580 that is present in gap 640. As ion plasma discharge 580 accelerates through gap 640, ion plasma discharge 580 will exit second holes 635 to create an ion discharge exhaust 637 that exerts a force sufficient to propel space-based generation unit 50. Another cathode 650 that is coupled to chassis 90 is disposed near ion discharge exhaust 637 and aligned with ion discharge exhaust 637, so as to emit electrons in the direction of an arrow 655. Electrons emitted by cathode 650 maintain a balance between positive and negative ions present in ion discharge exhaust 637. Maintaining balance between positive and negative ions in ion discharge exhaust 637 prevents ion discharge exhaust 637 from returning into ion thruster 460.

According to the invention, space-based power generation unit 50 is disposed in planetary orbit 60 about the sun 70. Disposing space-based power generation unit 50 near the sun 70 in this manner subjects space-based power generation unit 50 to greater heat flux compared to disposing space-based power generation unit 50 in satellite orbit about the earth 40. The greater heat flux may reduce operating efficiency of controller 160 and solar panel 100. Although not critical, it is nonetheless desirable that space-based power generation unit 100 be suitably cooled to mitigate such reductions in operating efficiency. Also, it would be desirable to generate additional electricity from solar energy 80 while space-based power generation unit 50 is being cooled.

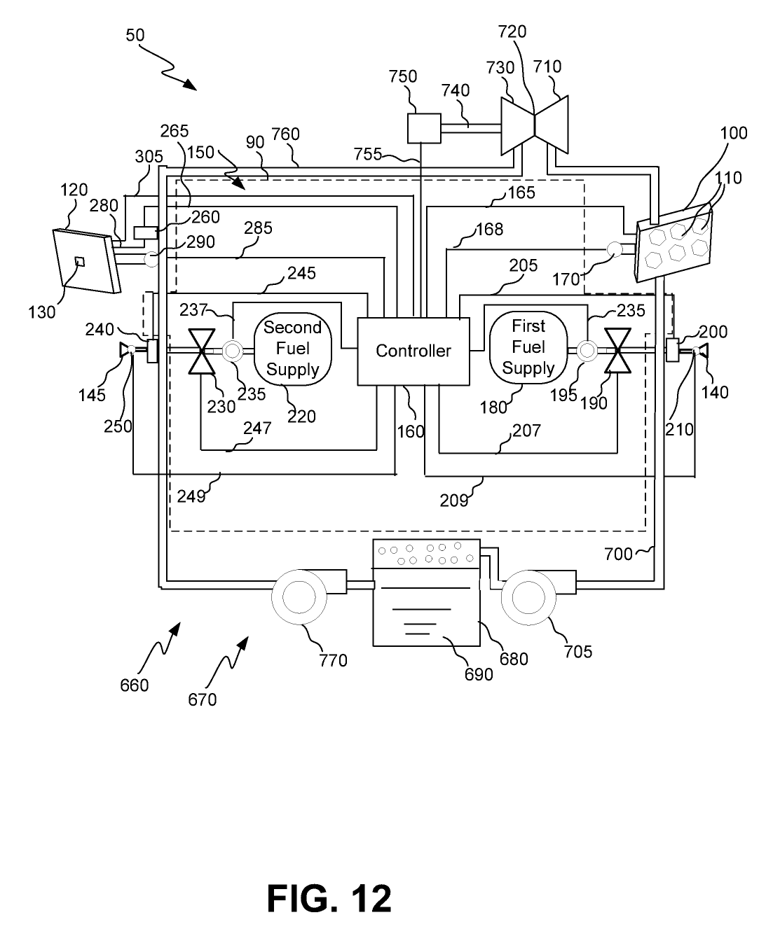

Therefore, referring to FIG. 12, there is shown a cooling subsystem, generally referred to as 660. As described in detail presently, cooling subsystem 660 is adapted to cool space-based power generation unit 50, while simultaneously generating additional electricity. In this regard, cooling subsystem 660 includes a first embodiment heat exchanger circuit, generally referred to as 670. Heat exchanger circuit 670 includes a boiler 680 containing a suitable coolant, such as a body of water 690. Other suitable coolants may be used as an alternative to water, such as florocarbons. In other words, the coolant may be selected from the group consisting essentially of water, chloroflorocarbon, hydrocloroflorocarbon and mixtures thereof. When coolant 690 is water, solar energy 80 from the sun 70 heats coolant 690 to generate steam that is pumped through a first conduit 700 by an electrically energizable first pump 705. The steam may flow through solar panel 100, if desired. The steam that might flow through solar panel 100 will be a steam-water mixture having a predetermined quality that is of lower temperature than solar energy 80. In this case, the steam-water mixture will tend to cool solar panel 100 to protect solar panel 100 from heat damage that might otherwise be caused by solar energy 80. The steam flows through first conduit 700 and into a high pressure side 710 of a turbine 720. The steam then flows from high pressure side 710 to a low pressure side 730 of turbine 720. As the steam flows to low pressure side 730, the steam rotates a turbine shaft 740 coupled to low pressure side 730 at one end of turbine shaft 740 and coupled to an electric generator 750 at another end of turbine shaft 740. As turbine shaft 740 rotates, electric generator 750 generates electricity that is conducted to controller 160, such as along a wire 755, for providing additional electricity to controller 160. As previously mentioned, controller 160 also receives electricity by means of solar panel 100. Thus, according to the invention, controller 160 will receive electricity by means of electric generator 750 in addition to receiving electricity by means of solar panel 100.

Referring again to FIG. 12, a second conduit 760 extends from low pressure side 730 of turbine 720 to boiler 680. As the steam leaves low pressure side 730 of turbine 720, the steam will enter second conduit 760. The second conduit 760 is disposed further away from the sun 70 than first conduit 700 and faces the coolness of space, rather than the heat flux from the sun 70, due to the orientation of space-based power generation unit relative to the sun 70. Therefore, the steam in second conduit 760 will tend to condense to liquid water. The liquid water will flow into boiler 680. An electrically energizable second pump 770 is integrally coupled to second conduit 760 for pumping the liquid water to boiler 680. It should be understood that both first pump 705 and second pump 770 are controllably operated by controller 160 to which pumps 705/770 are electrically connected. Pumps 705/770 are electrically connected to controller 160 by electricity-conducting wires (not shown). Conduits 700/760 may be configured as hollow walls substantially surrounding chassis 90, if desired, for purposes of more efficient and complete heat removal.

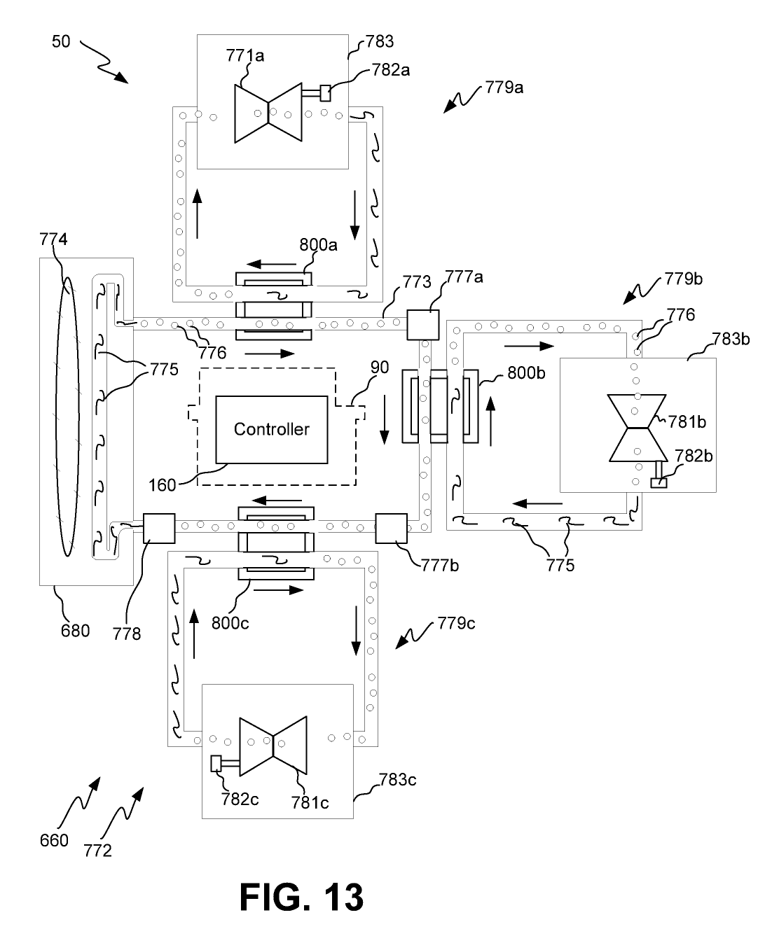

Referring to FIG. 13, there is shown a second embodiment heat exchanger circuit, generally referred to as 772. Second embodiment heat exchanger circuit 772 belongs to previously mentioned cooling subsystem 660 and is, therefore, an alternative to first embodiment heat exchanger circuit 670. It may be understood that, for reasons of clarity, parts have been removed from second embodiment heat exchanger circuit 772 that is shown in the figure. Second embodiment heat exchanger circuit 772 may be more efficient in removing heat chassis 90 when compared to the heat removal efficiency of first embodiment heat exchanger circuit 670. Second embodiment heat exchanger circuit 772 comprises a closed main heat transfer loop 773 surrounding chassis 90. Previously mentioned boiler 680 is coupled to main heat transfer loop 773, as shown. Solar energy 80 from the sun 70 establishes a heated region 774 within boiler 680. Heat from heated region 774 transfers to a liquid heat transfer medium or coolant 775 (e.g., water) present in a portion of main heat transfer loop 773. The main heat transfer loop 773 extends through boiler 680, as shown. The heat from heated region 774 causes the water 775 to convert to steam 776. Steam 776 travels along main heat transfer loop 773, generally in a direction as shown by the several arrows. A first steam compressor 777a may be coupled to main heat transfer loop 773 for compressing steam 776. First steam compressor 777a may be what is known in the art as a “jet compressor”, “thermocompressor” or “thermal compressor.” It is known that such a “jet compressor”, “thermocompressor” or “thermal compressor” is a steam-jet ejector that compresses steam at high pressures. Compressing steam 776 in this manner increases the amount of heat in steam 776. A second steam compressor 777b also may be coupled to main heat transfer loop 773 for further compressing steam 776 in order to further increase the amount of heat in steam 776. Moreover, a steam decompressor 778, which may be an electrically operable decompression valve, may be coupled to main heat transfer loop 773 for decompressing steam 776. Decompressing steam 776 returns steam 776 to liquid water 775, which flows into boiler 680 by means of main heat transfer loop 773. The liquid water 775 then receives heat from heated region 774, so that the liquid water 775 can be converted into steam 776 again. In addition, suitable electrically operated pumps (not shown) may be provided in main heat transfer loop 773 for pumping steam 776 and/or water 775 along main heat transfer loop 773.

Referring again to FIG. 13, a plurality of auxiliary heat transfer loops, generally referred to as 779a, 779b and 779c, are disposed adjacent to main heat transfer loop 773, so as to be in heat transfer communication with main heat transfer loop 773. Alternatively, auxiliary heat transfer loops 779a/b/c may be coupled to main heat transfer loop 773 while simultaneously being in heat transfer communication with main heat transfer loop 773 for purposes of increased heat transfer between main heat transfer loop 773 and auxiliary heat transfer loops 779a/b/c. In this case, auxiliary heat transfer loops 779 a/b/c are coupled to main heat transfer loop 773 by means of respective ones of a plurality of heat exchangers 800a, 800b and 800c, which may have a suitable heat transfer fluid (e.g., water) therein. In this case, heat is transferred from main heat transfer loop 773 to each of auxiliary heat transfer loops 779a/b/c by means of respective ones of heat exchangers 800a, 800b and 800c. As heat is transferred to auxiliary heat transfer loops 779a/b/c, water 775 in each of the auxiliary heat transfer loops 779a/b/c is converted to steam 776. The steam 776 in each auxiliary heat transfer loop 779a/b/c rotates a turbine 781a, 781b and 781c disposed in respective ones of auxiliary heat transfer loops 779a/b/c. Turbines 781 a/b/c, in turn, rotate respective ones of a plurality of electric generators 782a, 782b and 782c that are coupled to turbines 781 a/b/c for generating direct current electricity. The direct current electricity is conducted to controller 160, such as along a wire (not shown), for providing additional electricity to controller 160. As previously mentioned, controller 160 receives electricity by means of solar panel 100. Thus, according to the invention, controller 160 will receive additional electricity due to operation of electric generators 781a/b/c. Each of turbines 781a/b/c and electric generators 782a/b/c may be disposed in respective ones of a plurality of leak-tight housings 783a, 783b and 783c for avoiding leakage of water 775 and/or steam 776 from space-based generating unit 50 as water 775 and/or steam 776 passes through turbines 781a/b/c.

Referring yet again to FIG. 13, it may be appreciated that, although outer space lacks air, heat will nonetheless escape chassis 90 by means of infrared radiation. The additional electricity generated by electric generators 782a/b/c removes heat from steam 776 and sufficiently cools steam 776. If a large quantity of energy is desired, such as 1,000 times more or 10,000 times more compared to the amount of energy that can be supplied by a microwave satellite system in satellite orbit about the earth 40, then heat resistance capability of space-based power generation unit 50 is important. This is so because greater amounts of microwave energy can be generated the closer space-based power generation unit 50 is to the sun 70, which is where heat flux is greater. As shown in the several figures, first embodiment heat exchanger circuit 670 and second embodiment heat exchanger circuit 772 allow for cooling of space-based power generation unit 50 in order to mitigate undesirable effects of high heat flux received from the sun 70 as space-based power generation unit 50 orbits the sun 70.

It may be appreciated that the invention contemplates using any of the embodiments of solar power satellite systems 10/360/410/420/450/660 either alone or in combination. It may also be appreciated that the propulsion means 140/145/430/460 allow power generation unit 50 to achieve sufficient speed while in planetary orbit 60, so that the orbital centrifugal force acting on power generation unit 50 overcomes the centripetal gravitational force exerted by the sun 70.

### Illustrative Methods

An illustrative method associated with exemplary embodiments for arranging a solar power satellite system about the sun 70 for transmitting microwave energy 20 to the earth 40 will now be described.

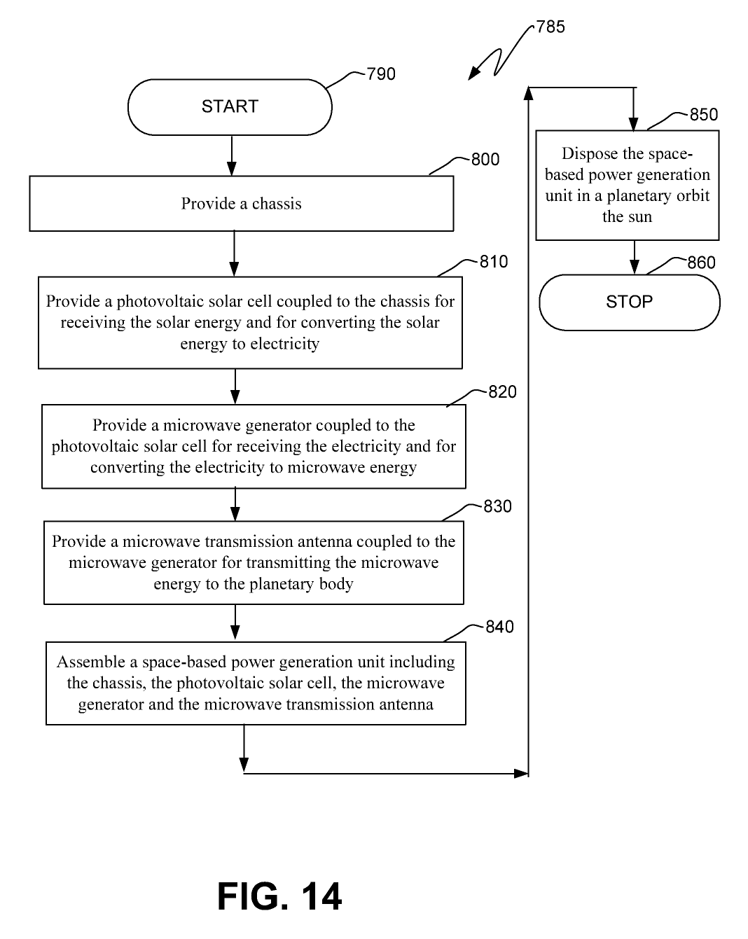

Referring to FIG. 14, an illustrative method 785 that is provided for arranging a solar power satellite system about the sun for transmitting microwave energy to the earth starts at a block 790. At a block 800, a chassis is provided. At a block 810, a photovoltaic solar cell coupled to the chassis is provided for receiving the solar energy and for converting the solar energy to electricity. At a block 820, a microwave generator coupled to the photovoltaic solar cell is provided for receiving the electricity and for converting the electricity to microwave energy. At a block 830, a microwave transmission antenna coupled to the microwave generator is provided for transmitting the microwave energy to the earth. At a block 840, a space-based power generation unit including the chassis, the photovoltaic solar cell, the microwave generator and the microwave transmission antenna is assembled. At a block 850, the space-based power generation unit is disposed in a planetary orbit the sun. The method stops at a block 860.

Other modifications and implementations will occur to those skilled in the art without departing from the spirit and the scope of the invention as claimed. For example, reflector unit 370 is shown as powered by solar panel 100. However, reflector unit 370 may be powered by an alternative energy source, such as a suitable fuel cell (not shown), comprising a solid oxide material (e.g., zirconia doped with yttria) capable of generating electricity electrochemically. Accordingly, the description hereinabove is not intended to limit the invention, except as indicated in the following claims.

Consequently, the solar power satellite system belonging to the invention comprises a space-based power generation unit arranged in planetary orbit about the sun. The space-based power generation unit comprises at least one photovoltaic solar cell adapted to receive solar energy and convert the solar energy to direct current electricity on-board the space-based power generation unit. A microwave generator receives the direct current electricity and converts the electricity into microwaves that are beamed to earth by means of a microwave antenna. The microwaves beamed to earth are received by a ground-based rectenna and converted to direct current electricity that is subsequently transformed into alternating current electricity by means of a direct current-to-alternating current converter. The alternating current electricity is then transmitted over electric transmission and distribution grids to an end user facility for use by an end user. The solar power satellite system further comprises a laser beacon positioned at the rectenna and a laser sensor disposed on the space-based power generation unit. The laser sensor senses the laser beacon in order to precisely direct the microwave energy to the rectenna near which the laser beacon is disposed. The space-based power generation unit is also provided with a propulsion device for adjustment of the space-based power generation unit relative to the rectenna and the sun. In addition, at least one reflector unit may be provided for reflecting the microwave energy from the space-based power generation unit to the earth.

Therefore, provided herein are a solar power satellite system for transmitting microwave energy to the earth and a method of arranging a solar power satellite system about the sun for transmitting microwave energy to the earth.

What is claimed is:

1. A solar power satellite system for transmitting microwave energy to the earth, the solar power satellite system comprising:
a space-based power generation unit adapted to be disposed in an orbit about the sun, the sun being capable of emitting solar energy, the space-based power generation unit including:
a chassis;
a photovoltaic solar cell coupled to the chassis for receiving the solar energy and for converting the solar energy to electricity;
a microwave generator coupled to the photovoltaic solar cell for receiving the electricity and for converting the electricity into microwave energy; and
a microwave transmission antenna coupled to the microwave generator for transmitting the microwave energy to the earth.

2. The solar power satellite system of claim 1, wherein the space-based power generation unit is deployable at a predetermined distance from the sun and relative to the earth for irradiating a predetermined area on the earth with the microwave energy.

3. The solar power satellite system of claim 1, further comprising a rectenna disposed on the earth and aligned with the microwave transmission antenna for receiving the microwave energy and for converting the microwave energy to direct current electricity.

4. The solar power satellite system of claim 3, further comprising a direct current-to-alternating current converter coupled to the rectenna for converting the direct current electricity to alternating current electricity.

5. The solar power satellite system of claim 4, further comprising an electrical transmission grid coupled to the direct current-to-alternating current converter for transmitting the alternating current electricity to an end user facility.

6. The solar power satellite system of claim 1, further comprising:
a laser beacon coupled to the rectenna for emitting a laser beam identifying location of the rectenna;
a laser beam sensor coupled to the microwave transmission antenna and adapted to be in sensing communication with the laser beam for aligning the microwave transmission antenna with the laser beacon.

7. The solar power satellite system of claim 6, further comprising a propulsion device coupled to the space-based power generation unit for orienting the space-based power generation unit relative to the laser beacon.

8. The solar power satellite system of claim 1, further comprising a space-based microwave reflector unit aligned with the microwave transmission antenna and the earth for reflecting the microwave energy from the microwave transmission antenna and to the earth.

9. A solar power satellite system for transmitting microwave energy to the earth, the solar power satellite system comprising:
a space-based power generation unit adapted to be disposed in an orbit about the sun, the sun being capable of emitting solar energy, the space-based power generation unit being deployable at a predetermined distance from the sun and relative to the earth for irradiating a predetermined area on the earth with the microwave energy, the space-based power generation unit including:
a chassis;
a photovoltaic solar cell coupled to the chassis for receiving the solar energy and for converting the solar energy into a first direct current electricity;
a microwave generator coupled to the photovoltaic solar cell for receiving the first direct current electricity and for converting the first direct current electricity into the microwave energy;
a microwave transmission antenna coupled to the microwave generator for transmitting the microwave energy to the earth; and
a rectenna disposed on the earth and aligned with the microwave transmission antenna for receiving the microwave energy and for converting the microwave energy into a second direct current electricity.

10. The solar power satellite system of claim 9, further comprising a direct current-to-alternating current converter coupled to the rectenna for converting the second direct current electricity to alternating current electricity.

11. The solar power satellite system of claim 10, further comprising an electrical transmission grid coupled to the direct current-to-alternating current converter for transmitting the alternating current electricity to an end user facility.

12. The solar power satellite system of claim 9, further comprising:
a laser beacon coupled to the rectenna for emitting a laser beam identifying location of the rectenna; and
a laser beam sensor coupled to the microwave transmission antenna and adapted to be in sensing communication with the laser beam for aligning the microwave transmission antenna with the laser beacon.

13. The solar power satellite system of claim 12, further comprising a propulsion device coupled to the space-based power generation unit for orienting the space-based power generation unit relative to the laser beacon.

14. The solar power satellite system of claim 9, further comprising a space-based microwave reflector unit aligned with the microwave transmission antenna and the earth for reflecting the microwave energy from the microwave transmission antenna and to the earth.

15. A method of arranging a solar power satellite system about the sun for transmitting microwave energy to the earth, the method comprising:
providing a chassis;
providing a photovoltaic solar cell coupled to the chassis for receiving solar energy and for converting the solar energy to electricity;
providing a microwave generator coupled to the photovoltaic solar cell for receiving the electricity and for converting the electricity to microwave energy;
providing a microwave transmission antenna coupled to the microwave generator for transmitting the microwave energy to the earth;
assembling a space-based power generation unit including the chassis, the photovoltaic solar cell, the microwave generator and the microwave transmission antenna; and
disposing the space-based power generation unit in an orbit about the sun.

16. The method of claim 15, wherein disposing the space-based power generation unit in the orbit includes:
deploying the space-based power generation unit at a predetermined distance from the sun; and
aligning the space-based power generation unit relative to the earth for irradiating a predetermined area on the earth with the microwave energy.

17. The method of claim 15, further comprising:
disposing a rectenna on the earth; and
aligning the rectenna with the microwave transmission antenna for receiving the microwave energy and for converting the microwave energy to direct current electricity.

18. The method of claim 17, further comprising coupling a direct current-to-alternating current converter to the rectenna for converting the direct current electricity to alternating current electricity.

19. The method of claim 18, further comprising coupling an electrical transmission grid to the direct current-to-alternating current converter for transmitting the alternating current electricity to an end user facility.

20. The method of claim 15, further comprising aligning a space-based microwave reflector unit with the microwave transmission antenna and the earth for reflecting the microwave energy from the microwave transmission antenna and to the earth.
